(19) United States
(12) Patent Application Publication
(10) Pub. No.: US 2005/0099151 A1
(43) Pub. Date: May 12, 2005

(54) Positioning/adjusting device for a shielding member

(76) Inventor: Pao Chen Lee, Yung Kang City (TW)

Correspondence Address: CHARLES E. BAXLEY, ESQ., 90 JOHN STREET, THIRD FLOOR, NEW YORK, NY, 10038, US

(21) Appl. No.: 10/712,814

(22) Filed: Nov. 12, 2003

(51) Int. Cl. G05B 1/06

(52) U.S. Cl. 318/640

(57) ABSTRACT

A positioning/adjusting device includes a main unit and a controlling device. The main unit includes a motor unit and a circuit assembly. The motor unit includes a motor for moving the outreaching/retracting member. The circuit assembly includes a detecting circuit for detecting turns of a disc driven by the motor unit. The data regarding the turns are sent to a central processing unit and stored in a memory. The central processing unit sends signals to a control circuit to control clockwise or counterclockwise rotation or stopping of the motor unit. The controlling device includes a button circuit, wherein when one of several buttons of the button circuit is pushed, a corresponding signal is sent to the central processing unit to thereby control clockwise or counterclockwise rotation or stopping of the motor unit and to thereby setting an uppermost position and a lowermost position of the outreaching/retracting member.

### BACKGROUND OF THE INVENTION

1. Field of the Invention

The present invention relates to a positioning/adjusting device for an outreaching/retracting such as an electric rolling door.

2. Description of the Related Art

It is usual to provide an electrically activated member such as an electric rolling door, an electric sliding door, an electric door curtain, or an electric venetian blind to shield the door or window of a house. Another electrically activated member includes a projection screen that is coiled up when not in use.

FIG. 5 of the drawings illustrates an outreaching/retracting device for an electrically activated member. The device includes an outreaching/retracting member 11′ (e.g., a rolling door), a motor 12′ for driving the outreaching/retracting member 11′, a controller 13′ for controlling the turning direction of the motor 12′, and a positioning/adjusting device 2′ for adjusting a positioning point for the outreaching/retracting member 11′.

The outreaching/retracting member 11′ is driven by the motor 12′ to move in an outreaching direction (i.e., the door-closing direction) or in a retracting direction (i.e., the door-opening direction). The positioning/adjusting device 2′ is mounted to a side of the motor 12′. The controller 13′ includes a box 131′, a plurality of buttons 132′ mounted in the box 131′, and wiring 133′ electrically connected at one end to the buttons 132′ and electrically connected at the other end to motor 12′. Thus, the motor 12′ is turned clockwise or counterclockwise or stopped when one of the buttons 132′ is pushed.

As illustrated in FIG. 6, the positioning/adjusting device 2′ includes a screw 21′, a first sliding block 22′, a second sliding block 23′, a first microswitch 24′, and a second microswitch 25′. The first and second microswitches 24′ and 25′ are respectively on the paths of the first and second sliding blocks 22′ and 23′.

An end of the screw 21′ is engaged with a bevel gear 26′, which, in turn, meshes with a bevel gear 121′ driven by the motor 12′. When the motor 12′ is activated to turn clockwise or counterclockwise, the screw 21′ turns in a corresponding direction and moves the first and second sliding blocks 22′ and 23′. When the first and second sliding blocks 22′ and 23′ respectively impinge the first and second microswitches 24′ and 25′, the motor 12′ is turned off, thereby controlling the open/closed position of the rolling door 11′.

It was, however, found that the open/closed position of the rolling door 11′ shifted after a period of time of use. In particular, the lower end of the rolling door 11′ was not in contact with the ground when the rolling door 11′ is in its closing position. In other cases, the rolling door 11′ still moved downward even though the lower end of the rolling door 11′ had contacted the ground, causing damage to the motor 12′. Adjustment of the positions of the first and second sliding blocks 22′ and 23′ was troublesome and time-consuming. Namely, accurate adjustment was not possible and the adjusting procedure is inconvenient.

### SUMMARY OF THE INVENTION

To mitigate and/or obviate the above drawbacks, the present invention provides a positioning/adjusting device for an outreaching/retracting member. The positioning/adjusting device includes a main unit and a controlling device. The main unit includes a motor unit and a circuit assembly. The motor unit includes a motor for moving the outreaching/retracting member in an outreaching direction or a retracting direction. The circuit assembly includes a circuit board, with a central processing unit, a memory, a detecting circuit, and a control circuit being mounted on the circuit board. The central processing unit is programmed to establish a plurality of operational procedures. The detecting circuit includes a rotatable disc driven by the motor unit and a photosensor for detecting a number of turns of the disc.

The disc includes a plurality of annularly spaced through-holes. The number of turns of the disc is detected based on the passage of light beams through the through-holes and blockage of the light beams by the disc. A signal regarding the number of turns of the disc is sent to the central processing unit and stored in the memory. The control circuit is coupled to an output of the central processing unit to activate the motor unit to turn clockwise or counterclockwise or to deactivate the motor unit when the central processing unit sends a signal to the control circuit.

The controlling device includes a button circuit that includes a plurality of buttons each of which sends a corresponding signal to the central processing unit when pushed, thereby controlling clockwise or counterclockwise rotation or stopping of the motor unit and thereby setting an uppermost position and a lowermost position of the outreaching/retracting member.

When setting the uppermost position or the lowermost position, the number of turns of the motor unit is detected by the detecting circuit and data of the number of turns of the motor unit are stored in the memory, providing a basis for closed and open positions of the outreaching/retracting member.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a positioning/adjusting device in accordance with the present invention.

FIG. 2 is a schematic block diagram of the positioning/adjusting device in accordance with the present invention.

FIG. 3 is a sectional view showing engagement between a motor unit and a detecting circuit in FIG. 2.

FIG. 4 is another block diagram of the positioning/adjusting device in accordance with the present invention.

FIG. 5 is a schematic view showing a conventional rolling door and a positioning/adjusting device for the rolling door.

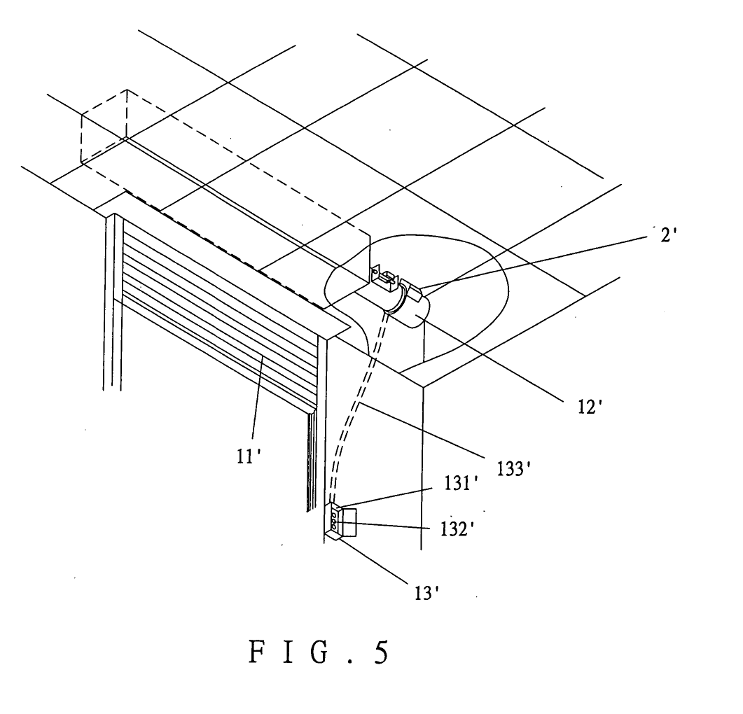

FIG. 6 is a sectional view of the positioning/adjusting device in FIG. 5.

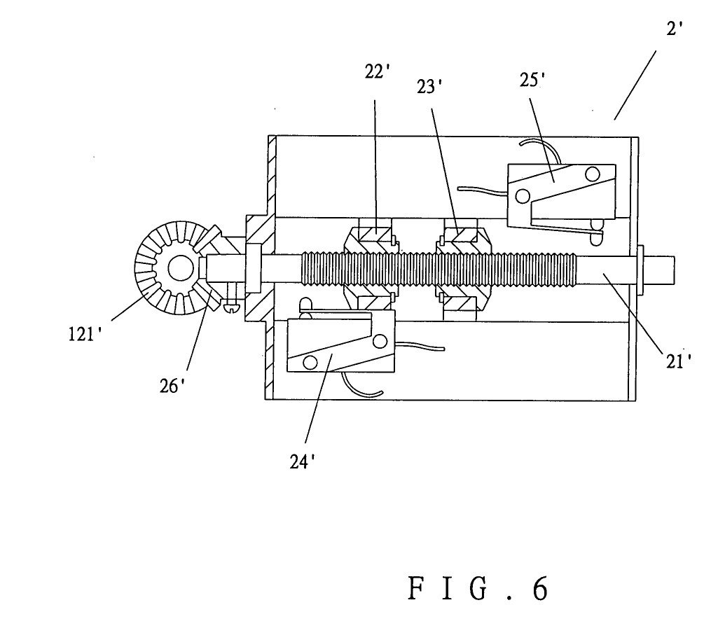

### DETAILED DESCRIPTION OF THE PREFERRED EMBODIMENT

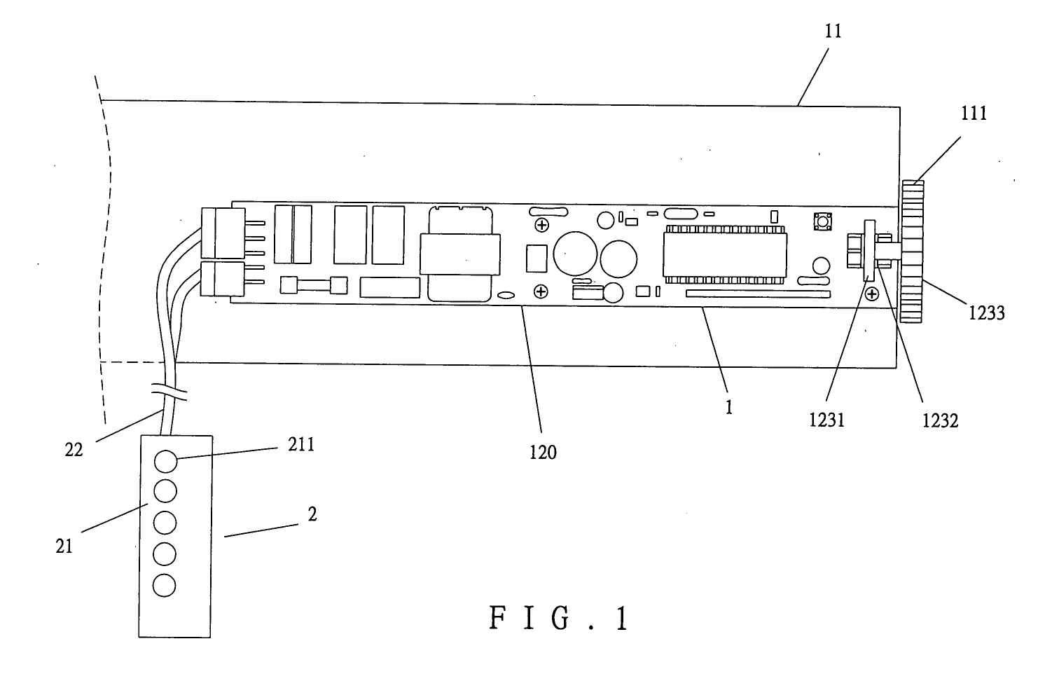

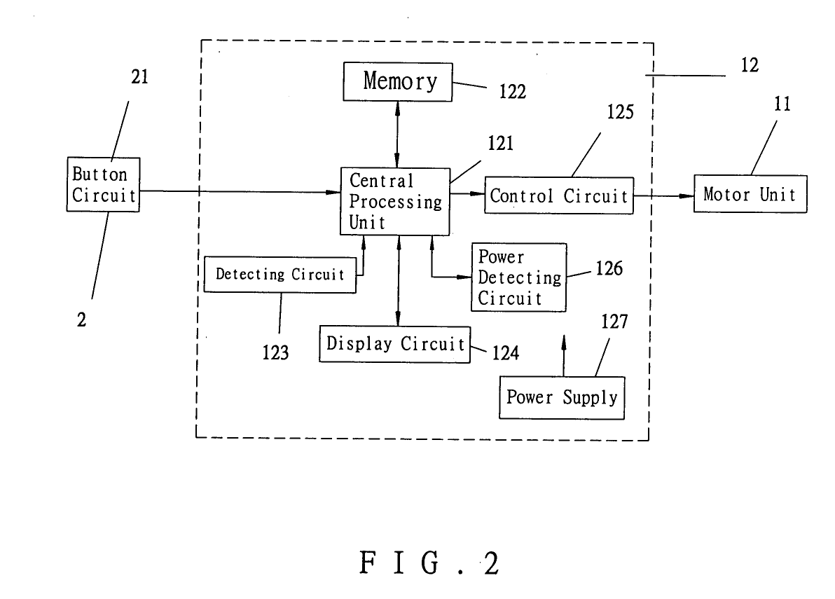

Referring to FIGS. 1 and 2, a positioning/adjusting device in accordance with the present invention generally comprises a main unit 1 and a controlling device 2 for controlling the main unit 1. The main unit 1 is engaged with an outreaching/retracting member that can be moved in an outreaching direction or a retracting direction. The outreaching/retracting member is a shielding member such as a coilable plate-like member (such as a rolling door), a plate with a fixed length, or a collapsible door.

In this embodiment, the main unit 1 includes a motor unit 11 and a circuit assembly 12. The main unit 1 can be fixed to a wall or any fixed object. The motor unit 11 includes a motor (not labeled) and a gear train (not labeled) for driving a drive gear 111, which, in turn, actuates the outreaching/retracting member.

The circuit assembly 12 includes a circuit board 120 on which a central processing unit 121, a memory 122, a detecting circuit 123, a display circuit 124, a control circuit 125, a power detecting circuit 126, and a power supply 127 are mounted. The central processing unit 121 is programmed to proceed with operational procedures such as decoding, operation, sending executing signals, and controlling. The memory 122 stores data accessible to the central processing unit 121.

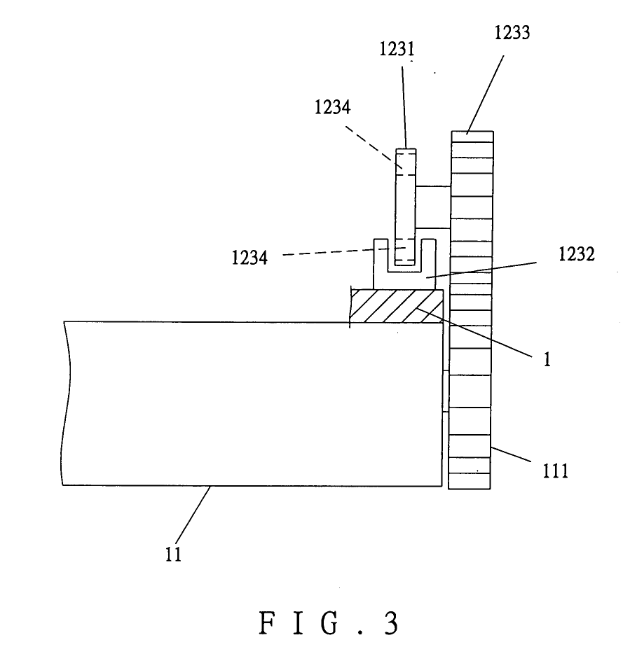

As illustrated in FIG. 3, the detecting circuit 123 includes a disc 1231 that is turned by the motor unit 11. The detecting circuit 123 further includes a photosensor 1232 for detecting the turns of the disc 1231 (i.e., how many turns the disc 1231 rotates). In this embodiment, the disc 1231 is coupled with a gear 1233 that is coupled with the drive gear 111 of the motor unit 11. Alternatively, the disc 1231 can be directly driven by the motor unit 11. In another embodiment, the disc 1231 is mounted to and driven by another motor (not shown) that has a smaller power and that turns synchronously with the motor unit 11.

The disc 1231 includes a plurality of annularly spaced through-holes 1234. When the respective through-hole 1234 is not aligned with the photosensor 1323, light beam from a transmitter (not shown) is blocked by the disc 1231. When the respective through-hole 1234 comes across the photosensor 1232, the light beam incident to the photosensor 1232 indicates the angular phase of the disc, thereby achieving the function of calculating the turns of the disc 1231. The corresponding signal is sent to the central processing unit 121, and the corresponding number of turns of the motor unit 11 is recorded accordingly. The data of the turns of the motor unit 11 are transmitted via the detecting circuit 123 to the central processing unit 121 and become a basis for corresponding operation and execution.

The display circuit 124 is coupled to the central processing unit 121 and displays the working status of the central processing unit 121. The display circuit 124 may include a plurality of light-emitting diodes (not shown) and an optional sound effect circuit (not shown).

The control circuit 124 is coupled to an output of the central processing unit 121 to control clockwise or counterclockwise rotation or stopping of the motor unit 11 upon command signals from the central processing unit 121.

The power detecting circuit 126 is also coupled to the central processing unit 121. The power detecting circuit 216 sends a signal to the central processing unit 121 when a sudden voltage change occurs as a result of out of electricity service. When the central processing unit 121 receives the corresponding signal from the power detecting circuit 216, the data of execution of programs before out of electricity service are temporarily stored, and the remaining operation of the programs is executed when the electricity supply becomes normal. This avoids re-execution of the whole programs by the central processing unit 121.

The power supply 127 supplies electricity to all of the circuits associated with the main unit 1, such as the central processing unit 121, the memory 122, the detecting circuit 123, the display circuit 124, the control circuit 125, and the power detecting circuit 126.

The controlling device 2 includes a button circuit 21 and a wiring 22 connected between the button circuit 21 and the main unit 1. The button circuit 21 includes a plurality of buttons 211 that are electrically coupled via the wiring 22 to the central processing unit 121 of the circuit assembly 12. For an electric rolling door or curtain that is moved upward/downward, pressing of the respective button 211 causes upward movement, downward movement, stopping, setting, and minor adjustment of, e.g., a rolling door. For example, when the main unit 1 is on, the central processing unit 121 detects whether a button 211 is pushed. If yes, the motor unit 11 is activated to move the rolling door upward or downward or to stop the rolling door. Operation of the upward/downward movement as well as stopping of the rolling door is conventional and therefore not described in detail.

Setting and minor adjustment of the rolling door will now be described.

For setting the lowermost positioning point (i.e., the lowermost position) of an electric rolling door, an electric window, or electric curtain in accordance with the present invention, the setting button is pushed for one (1) second and then released. The downward button is then pushed and remained in the pushed position until the rolling door reaches a predetermined position where the lower end of the rolling door is usually in contact with the ground. The stop button is then pushed to finish the setting procedure. The lowermost position of the rolling door is thus set.

For setting the uppermost position of the rolling door, the upward button is pushed until the lower end of the rolling door reaches another predetermined position. The stop button is then pushed to finish the setting procedure. The uppermost position of the rolling door is thus set.

In the above setting procedures, the detecting circuit 123 stores the data of the number of turns of the disc 1231 into the memory 122 via the central processing unit 121, with the data being used as the basis for determining the uppermost and lowermost positions (i.e., the open and closed positions) of the rolling door.

After the setting procedures, in a case that the upward button or the downward button is pushed, the central processing unit 121 outputs a signal to the control circuit 125 to thereby control clockwise or counterclockwise rotation of the motor unit 11, which, in turn, causes upward or downward movement of the rolling door. The central processing unit 121 deactivates the motor unit 11 when the number of turns of the disc 1231 during the upward or downward movement of the rolling door is equal to the data stored in the memory 122. The rolling door is thus stopped in the predetermined uppermost or lowermost position. In a case that the detecting circuit 123 detects that the number of turns of the disc 1231 within a predetermined time (e.g., 2 seconds) is greater that the data stored in the memory 122, the main unit 1 automatically stops. The motor unit 11 is deactivated, and the sound circuit or light-emitting diodes in the display circuit 124 is activated to remind the user to proceed with maintenance.

For minor adjustment, the minor adjusting button is pushed for one (1) second to begin the minor adjusting procedure. The upward or downward is then pushed. The central processing unit 121 sends a signal upon each push, causing the control circuit 125 to activate the motor unit 11 to turn clockwise or counterclockwise through a predetermined number of turns (e.g., 1 or 2 turns), which can be varied according to need. This adjusts the position of the rolling door in a minor extent. The stop button is then pushed to finish the minor adjusting procedure.

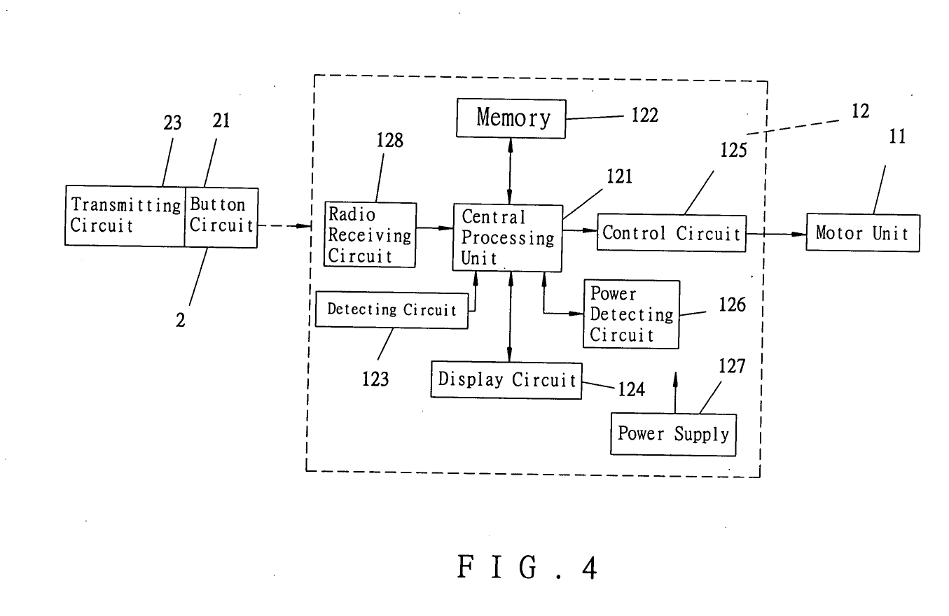

FIG. 4 illustrates another embodiment of the present invention, wherein the main unit 1 includes a radio receiving circuit 128, and the controlling device 2 includes a transmitting circuit 23 that sends signals to the radio receiving circuit 128, which, in turn, activates or deactivates the motor unit 11. The main unit 1 is mounted to a left side or right side of the motor unit 11, and the central processing unit 121 is correspondingly programmed to activate the motor unit 11 to turn in the desired direction.

Although the invention has been explained in relation to its preferred embodiment, it is to be understood that many other possible modifications and variations can be made without departing from the scope of the invention as hereinafter claimed.

1. A positioning/adjusting device for an outreaching/retracting member, comprising:
a main unit including a motor unit and a circuit assembly, the motor unit including a motor for moving the outreaching/retracting member in an outreaching direction or a retracting direction, the circuit assembly including a circuit board, with a central processing unit, a memory, a detecting circuit, and a control circuit being mounted on the circuit board, the central processing unit being programmed to establish a plurality of operational procedures, the detecting circuit including a rotatable disc driven by the motor unit and a photosensor for detecting a number of turns of the disc, the disc including a plurality of annularly spaced through-holes, the number of turns of the disc being detected based on the passage of light beams through the through-holes and blockage of the light beams by the disc, a signal regarding the number of turns of the disc being sent to the central processing unit and stored in the memory, the control circuit being coupled to an output of the central processing unit to activate the motor unit to turn clockwise or counterclockwise or to deactivate the motor unit when the central processing unit sends a signal to the control circuit; and
a controlling device including a button circuit, the button circuit including a plurality of buttons each of which sends a corresponding signal to the central processing unit when pushed, thereby controlling clockwise or counterclockwise rotation or stopping of the motor unit and thereby setting an uppermost position and a lowermost position of the outreaching/retracting member;
wherein when setting one of the uppermost position and the lowermost position, the number of turns of the motor unit is detected by the detecting circuit and data of the number of turns of the motor unit are stored in the memory, providing a basis for closed and open positions of the outreaching/retracting member.

2. The positioning/adjusting device for an outreaching/retracting member as claimed in claim 1, wherein the circuit assembly of the main unit further includes a power detecting circuit that sends a signal to the central processing unit when out of electricity service, the central processing unit storing data regarding execution of programs before out of electricity service in the memory, and the central processing unit proceeding with remaining operation of the programs when electricity supply becomes normal.

3. The positioning/adjusting device for an outreaching/retracting member as claimed in claim 1, wherein the main unit includes a radio receiving circuit, the controlling device including a transmitting circuit for sending signals to the radio receiving circuit.
